(19) United States
(12) Patent Application Publication
(10) Pub. No.: US 2024/0063907 A1
(43) Pub. Date: Feb. 22, 2024

(54) WIRELESS COMMUNICATION METHOD AND WIRELESS COMMUNICATION APPARATUS

(71) Applicant: NIPPON TELEGRAPH AND TELEPHONE CORPORATION, Tokyo (JP)

(72) Inventors: Kota ITO, Musashino-shi (JP); Mizuki SUGA, Musashino-shi (JP); Takuto ARAI, Musashino-shi (JP); Yushi SHIRATO, Musashino-shi (JP); Daisei UCHIDA, Musashino-shi (JP); Naoki KITA, Musashino-shi (JP); Takeshi ONIZAWA, Musashino-shi (JP)

(73) Assignee: NIPPON TELEGRAPH AND TELEPHONE CORPORATION, Tokyo (JP)

(21) Appl. No.: 18/269,746

(22) PCT Filed: Jan. 22, 2021
(86) PCT No.: PCT/JP2021/002291

§ 371 Date: Jun. 26, 2023

(51) Int. Cl. H04B 10/2575; H04B 10/516

(52) U.S. Cl. CPC H04B 10/2575; H04B 10/516

(57) ABSTRACT

A radio communication method performed by a radio communication device includes an inverse fast Fourier transform step of performing inverse fast Fourier transform on a digital electric signal associated with a downlink radio signal, a digital-to-analogue conversion step of converting the digital electric signal subjected to the inverse fast Fourier transform into a first analogue electric signal, an electro-optic conversion step of converting the first analogue electric signal into an optical signal, a step of transmitting the optical signal, a photoelectric conversion step of converting the transmitted optical signal into a second analogue electric signal, and a step of transmitting the downlink radio signal corresponding to the second analogue electric signal.

### TECHNICAL FIELD

The present invention relates to a wireless communication method and a wireless communication apparatus.

### BACKGROUND ART

For the spread of fifth generation mobile communication system (called “5G” hereinafter) and local 5G, a base station is being installed in a radio communication service providing area. The base station used for 5G and local 5G includes a centralized unit (CU), a distributed unit (DU), and a radio unit (RU) (refer to NPD 1). In addition, a plurality of combinations is defined as combinations of the centralized unit, the distributed unit, and the radio unit (refer to NPD 2).

### CITATION LIST

### Non Patent Documents

[NPD 1] Umesh and 3 others, “0-RAN Fronthaul Specification Outline”, NTT DOCOMO Technical Journal Vol. 27, No. 1 (April 2019)
[NPD 2] NGMN (Next Generation Mobile Networks) Alliance, “NGMN Overview on 5G RAN Functional Decomposition”, 2018

### SUMMARY OF INVENTION

### Technical Problem

FIG. 18 is a diagram showing a configuration example of a conventional radio communication system of 5G and local 5G. The radio communication system includes a host device, a centralized unit, a distributed unit, and one or more radio units 200.

In FIG. 18, the radio unit 200-1 is an existing radio unit in a radio communication service providing area. The radio unit 200-1 executes radio communication with a radio terminal (not shown) in the cover area 201-1 (cell).

The 5G and local 5G use a radio wave of a high frequency band (a millimeter wave band) for communication. Generally, the propagation distance of radio wave in a high frequency band is short. Furthermore, the straightness of radio wave in the high frequency band is high. For this reason, a radio wave in a high frequency band is easily shielded by the shielding object. When the radio wave is shielded by the shielding object, an area where communication becomes difficult may occur.

In FIG. 18, an area 202 is an area where communication becomes difficult because a part of the radio wave transmitted from the radio unit 200-1 is shielded by the shielding object 110. The area 202 is generated in a part of the cover area 201-1 of the radio unit 200-1. In order to expand the provision area of the radio communication service, a new radio unit 200 is installed in addition to the existing radio unit 200. In FIG. 18, the radio unit 200-2 is newly installed. The radio unit 200-2 executes radio communication with a radio terminal (not shown) in a cover area 201-2 including the area 202.

However, since the conventional radio unit 200 includes a signal processing unit, a D/A conversion unit (a digital-to-analogue conversion unit), a A/D conversion unit (an analogue-to-digital conversion unit), and an antenna element, it is heavy and large. Further, the power consumption of the conventional radio unit 200 is large. For these reasons, conventionally, it is impossible to suppress an increase in the facility cost for expanding the radio communication service providing area.

In view of such circumstances, an objective of the present invention is to provide a radio communication method and a radio communication device capable of suppressing the increase in the facility cost for expanding the radio communication service providing area.

### Solution to Problem

An aspect of the present invention is a radio communication method performed by a radio communication device, the radio communication method includes an inverse fast Fourier transform step of performing inverse fast Fourier transform on a digital electric signal associated with a downlink radio signal, a digital-to-analogue conversion step of converting the digital electric signal subjected to the inverse fast Fourier transform into a first analogue electric signal, an electro-optic conversion step of converting the first analogue electric signal into an optical signal, a step of transmitting the optical signal, a photoelectric conversion step of converting the transmitted optical signal into a second analogue electric signal, and a step of transmitting the downlink radio signal corresponding to the second analogue electric signal.

An aspect of the present invention is a radio communication device including an inverse fast Fourier transform unit that performs inverse fast Fourier transform on a digital electric signal associated with a downlink radio signal, a digital-to-analogue conversion unit that converts the digital electric signal subjected to the inverse fast Fourier transform into a first analogue electric signal, an electro-optic conversion unit that converts the first analogue electric signal into an optical signal, an optical fiber that transmits the optical signal, a photoelectric conversion unit that converts the transmitted optical signal into a second analogue electric signal, and an antenna element that transmits the downlink radio signal corresponding to the second analogue electric signal.

### Advantageous Effects of Invention

According to the present invention, it is possible to suppress an increase in facility cost for expanding a radio communication service providing area.

### BRIEF DESCRIPTION OF DRAWINGS

FIG. 1 is a diagram showing a configuration example of a radio communication system according to each embodiment.

FIG. 2 is a diagram showing a configuration example of a radio unit and an extension unit according to a first embodiment.

FIG. 3 is a diagram showing an operation example of the radio unit and the extension unit according to the first embodiment.

FIG. 4 is a diagram showing a configuration example of a radio unit and an extension unit according to a modification example of the first embodiment.

FIG. 5 is a diagram showing a configuration example of a radio unit and an extension unit according to a second embodiment.

FIG. 6 is a diagram showing a configuration example of a radio unit and an extension unit according to a third embodiment.

FIG. 7 is a diagram showing a configuration example of a radio unit and an extension unit according to a fourth embodiment.

FIG. 8 is a diagram showing a configuration example of a radio unit and an extension unit according to a fifth embodiment.

FIG. 9 is a diagram showing a configuration example of a radio unit and an extension unit according to a sixth embodiment.

FIG. 10 is a diagram showing a configuration example of a radio unit and an extension unit according to a seventh embodiment.

FIG. 11 is a diagram showing a configuration example of a radio unit and an extension unit according to an eighth embodiment.

FIG. 12 is a diagram showing a configuration example of a radio unit and an extension unit according to a ninth embodiment.

FIG. 13 is a diagram showing a configuration example of a radio unit and an extension unit according to a tenth embodiment.

FIG. 14 is a diagram showing a configuration example of a radio unit and an extension unit according to an eleventh embodiment.

FIG. 15 is a diagram showing an operation example of a radio unit and an extension unit according to an eleventh embodiment.

FIG. 16 is a diagram showing a configuration example of a radio unit and an extension unit according to a modification example of the eleventh embodiment.

FIG. 17 is a diagram showing a configuration example of a hardware of a base station according to each embodiment.

FIG. 18 is a diagram showing a configuration example of a radio communication system of 5G and local 5G according to a conventional embodiment.

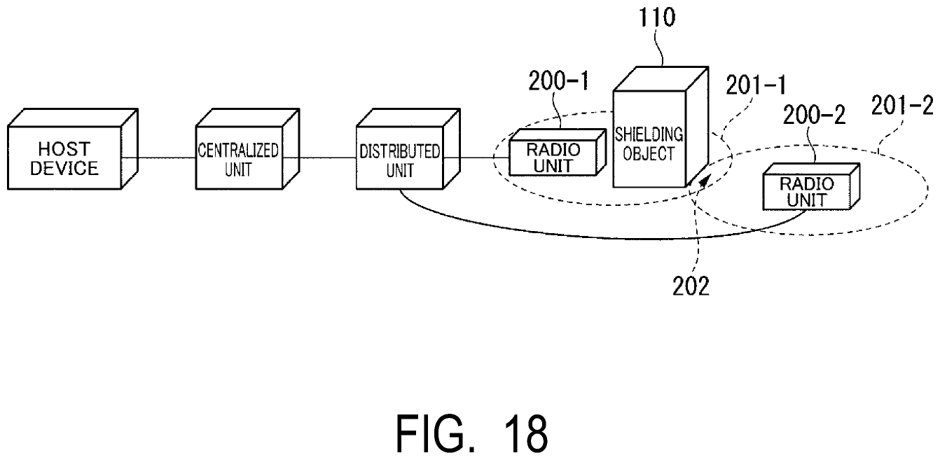

### DESCRIPTION OF EMBODIMENTS

An embodiment of the present invention will be described in detail with reference to the drawings.

(Overview)

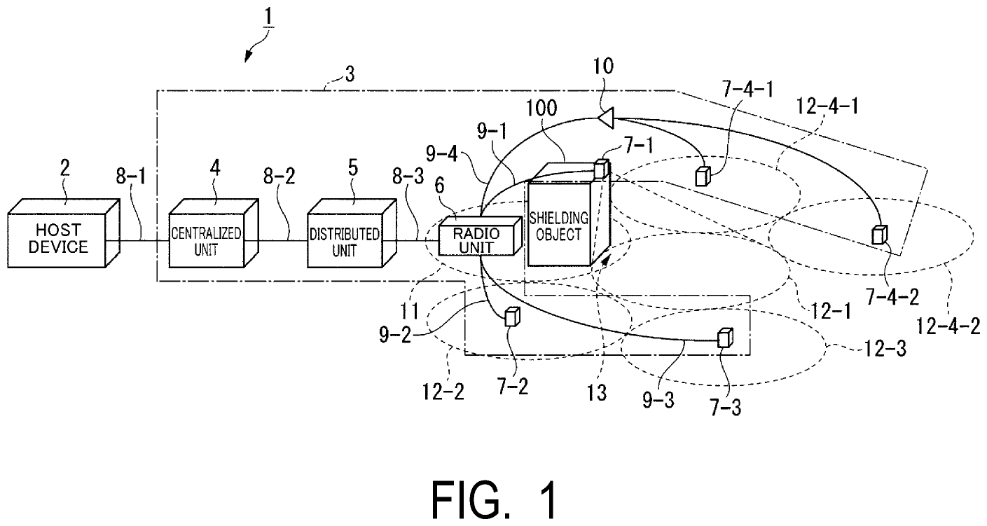

FIG. 1 is a diagram showing a configuration example of a radio communication system 1 according to each embodiment. The radio communication system 1 includes a host device 2 and a base station 3. The base station 3 includes a centralized unit 4 (CU), a distributed unit 5 (DU), and a radio unit 6 (RU).

The base station 3 includes the centralized unit 4, the distributed unit 5, and the radio unit 6. The radio unit 6 includes one or more extension units 7 (antenna unit). The extension units 7 are arranged in multiple planes in the radio communication service providing area.

The host device 2 and the centralized unit 4 are connected to each other by using a coaxial cable 8-1 (a communication line). The centralized unit 4 and the distributed unit 5 are connected to each other by using a coaxial cable 8-2 (a communication line). The distributed unit 5 and the radio unit 6 are connected to each other by using a coaxial cable 8-3 (a communication line).

The radio unit 6 and the extension unit 7 are connected to each other by using an optical fiber 9. That is, the extension unit 7 extends from the radio unit 6 through the optical fiber 9. The optical fiber 9 may be M single core fibers (M is an integer 1 or more) or a multi-core fiber having M cores.

In FIG. 1, the radio unit 6 and the extension unit 7-1 are connected by point-to-point (P-P), as an example. In FIG. 1, the two extension units 7-4 and the radio unit 6 are connected by a passive optical network (PON). In FIG. 1, the passive optical network includes an optical fiber 9-4 and an optical splitter 10 (a branching unit). The passive optical network is, for example, a WDM-PON (Wavelength Division Multiplexing-Passive Optical Network), or a TDM-PON (Time Division Multiplexing-Passive Optical Network).

The host device 2 outputs the downlink data to the centralized unit 4 (CU). The centralized unit 4 generates a downlink stream (a digital electric signal) by executing predetermined signal processing (for example, packetizing) on the downlink data. The centralized unit 4 outputs the downlink stream to the distributed unit 5 (DU). The distributed unit 5 generates M downlink streams (digital electric signals corresponding to radio signals) by executing predetermined signal processing (for example, encoding) for the downlink stream. The distributed unit 5 outputs M downlink streams to the radio unit 6.

In the radio communication system 1, for example, a radio wave of a high frequency band (a millimeter wave band) is used for communication. The radio communication service provided in the radio communication system 1 is, for example, a radio communication service of 5G and local 5G. A shielding object 100 may exist in the radio communication service providing area of the radio communication system 1. The shielding object 100 is, for example, a building. A cover area 11 is a cell of the radio unit 6.

The extension unit 7-n (n is an integer of 1 or more) transmits the downlink radio signal to a radio terminal (not shown) located in the cover area 12-n. The extension unit 7-n may receive the uplink radio signal from the radio terminal (not shown) located in the cover area 12-n.

The shielding object 100 shields a part of the radio signal of the radio unit 6. The area 13 is an area where communication becomes difficult because a part of the radio wave transmitted from the radio unit 6 is shielded by the shielding object 100. In FIG. 1, the area 13 is formed in a part of the cover area 11 of the radio unit 6. In FIG. 1, the extension unit 7-1 is installed at an upper position (a higher position) of the shielding object 100 as an example. Thus, the extension unit 7-1 executes radio communication with a radio terminal (not shown) in the cover area 12-1 including the area 13.

The extension unit 7-n includes M antenna elements and M photoelectric conversion units. The extension unit 7-n may not include a signal processing unit for executing predetermined radio front end processing (for example, frequency conversion processing). The extension unit 7-n may include an amplifier for amplifying the signal intensity.

The radio unit 6 transmits the downlink optical signal to the extension unit 7-n by using an analogue RoF (Radio-over-Fiber). In the analogue RoF, an optical signal intensity-modulated in accordance with the radio signal is transmitted through the optical fiber. The photoelectric conversion unit of the extension unit 7-n converts the downlink optical signal transmitted through the optical fiber 9 by using the analogue RoF into an analogue electric signal. The photoelectric conversion unit of the extension unit 7-n takes out the downlink radio signal from the optical signal by using photoelectric (Optical-to-Electrical) conversion to the optical signal transmitted through the optical fiber 9. One or more antenna elements of the extension unit 7-n transmit the downlink radio signal to the radio terminal (not shown) in the cover area 12. The radio terminal (not shown) in the cover area 12 separates the downlink radio signal into M streams corresponding to the downlink radio signal by signal processing such as MIMO (Multiple Input multiple Output) signal processing.

### First Embodiment

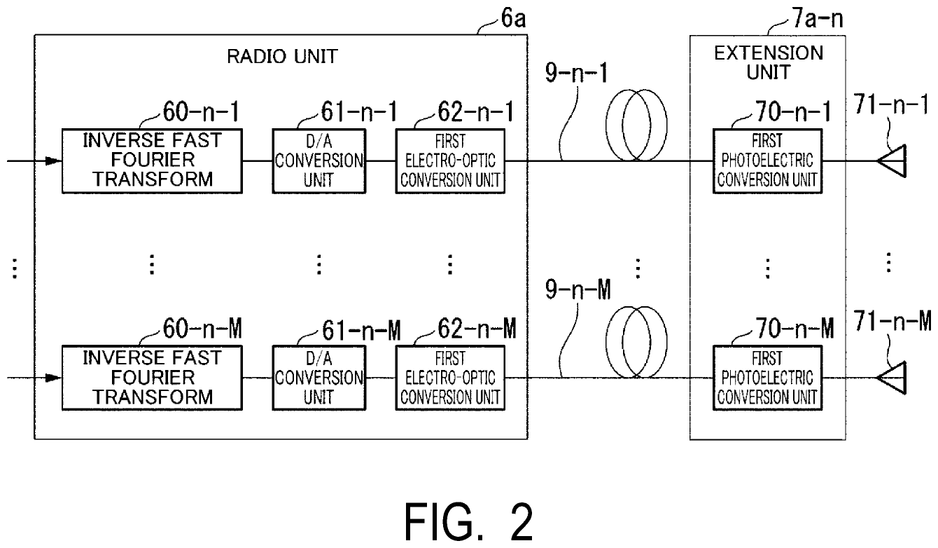

FIG. 2 is a diagram showing a configuration example of a radio unit 6a and an extension unit 7a-n according to a first embodiment. The radio unit 6a corresponds to the radio unit 6 shown in FIG. 1. The extension unit 7a-n corresponds to the extension unit 7-n shown in FIG. 1. In the first embodiment, the radio unit 6a and the extension unit 7a-n do not need to perform beam forming of the downlink radio signal.

The radio unit 6a includes M combinations (systems) of an inverse fast Fourier transform unit 60-n, a D/A conversion unit 61-n (a digital-to-analogue conversion unit) and a first electro-optic conversion unit 62-n. The extension unit 7a-n includes M combinations (systems) of the first photoelectric conversion unit 70-n and the antenna element 71-n. Note that the extension unit 7a-n may include M amplifiers for amplifying the intensity of the analogue electric signal or the optical signal.

The first electro-optic conversion unit 62-n and the first photoelectric conversion unit 70-n are connected to each other by using the optical fiber 9-n. The optical fiber 9-n may be M single core fibers or a multi-core fiber having M cores.

Next, an operation example of the radio unit 6a and the extension unit 7a will be described.

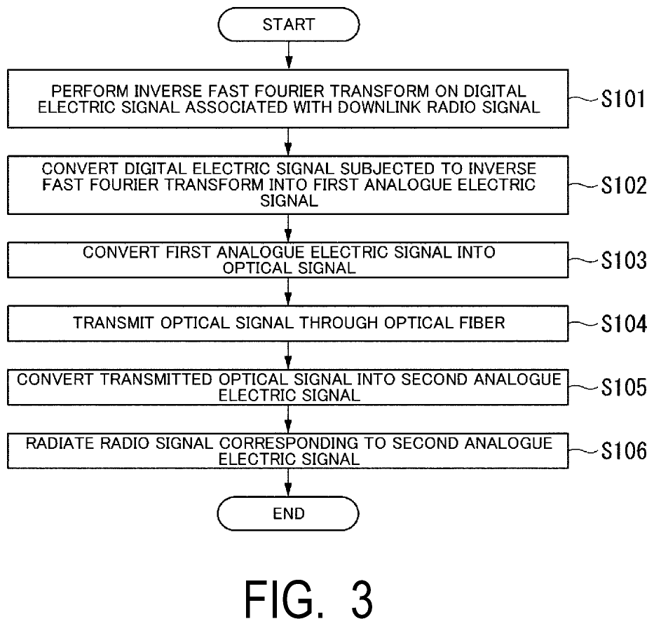

FIG. 3 is a diagram showing an operation example of the radio unit 6a and the extension unit 7a according to the first embodiment. The radio unit 6a acquires M downlink streams (digital electric signals associated with radio signals) from the distributed unit 5.

A stream “#m” (m is an integer equal to or more than 1 and equal to or less than M) is inputted to an inverse fast Fourier transform unit 60-n-m. For example, a stream “#1” is inputted to an inverse fast Fourier transform unit 60-n-1. For example, a stream “#2” is inputted to an inverse fast Fourier transform unit 60-n-2.

An inverse fast Fourier transform unit 60-n-m performs inverse fast Fourier transform (IFFT) to the digital electric signal (stream “#m”) associated with the downlink radio signal. The inverse fast Fourier transform unit 60-n-m outputs the digital electric signal subjected to inverse fast Fourier transform to a D/A conversion unit 61-n-m (step S101).

The D/A conversion unit 61-n-m converts the digital electric signal subjected to inverse fast Fourier transform by the inverse fast Fourier transform unit 60-n-m into the first analogue electric signal. The D/A conversion unit 61-n-m outputs the first analogue electric signal to a first electro-optic conversion unit 62-n-m (step S102).

The first electro-optic conversion unit 62-n-m converts the first analogue electric signal into an optical signal by using electro-optic (Electrical-to-Optical) conversion for the first analogue electric signal (step S103). The first electro-optic conversion unit 62-n-m transmits the optical signal through an optical fiber 9-n-m. That is, the optical fiber 9-n-m transmits the optical signal corresponding to the first analogue electric signal to a first photoelectric conversion unit 70-n-m (step S104).

The first photoelectric conversion unit 70-n-m converts the optical signal transmitted by the optical fiber 9-n-m into a second analogue electric signal (step S105). The antenna element 71-n-m radiates a radio signal corresponding to the second analogue electric signal converted by the first photoelectric conversion unit 70-n-m (step S106). In this way, the optical signal is transmitted using the analogue RoF.

As described above, the inverse fast Fourier transform unit 60-n-m performs inverse fast Fourier transform on the digital electric signal associated with the downlink radio signal. The D/A conversion unit 61-n-m (the digital to analogue conversion unit) converts the digital electric signal subjected inverse fast Fourier transform into the first analogue electric signal. The first electro-optic conversion unit 62-n-m converts the first analog electric signal into the optical signal. The optical fiber 9-n-m transmits the optical signal to the first photoelectric conversion unit 70-n-m. The first photoelectric conversion unit 70-n-m converts the transmitted optical signal into the second analogue electric signal. The antenna element 71-n-m transmits the downlink radio signal corresponding to the second analogue electric signal.

Thus, it is possible to suppress the increase in facility cost for expanding the radio communication service providing area.

That is, the conventional radio unit and the antenna are integrated without being connected to each other by optical fiber, and correspond to each other in a one-to-one manner. In addition, the conventional radio unit includes a radio front end processing unit, a digital-to-analogue conversion unit, and an analogue-to-digital conversion unit. Conventionally, when the radio communication service providing area is expanded, a large number of radio units must be installed in the radio communication service providing area in accordance with frequency characteristics such as linearity and attenuation of millimeter waves. In addition, in the radio communication service providing area, it is sometimes difficult to install the radio unit at a high place such as a wall surface, a traffic light, or a street lamp. Furthermore, the power consumption of the radio unit may be high. For these reasons, there are problems such as the increase in cost of facility investment.

On the other hand, in the first embodiment, the radio unit 6 and the extension unit 7 (antenna unit) are connected by the optical fiber 9. In addition, the radio unit 6 may not be integrated with the centralized unit 4 and the distributed unit 5. In the first embodiment, it is not necessary to install many radio units 6 in the radio communication service providing area, and it is sufficient to newly install the low-cost extension unit 7a in the providing area, so that the increase in the cost of the facility investment can be suppressed. And, the extension unit 7a is smaller and lighter than the radio unit 6a. Therefore, the extension unit 7a can be easily installed even in the high place, the wall surface, the traffic light, the street lamp or the like (the place where installation load is large).

In addition, the power consumption of the radio unit 6a is small. Further, since the optical fiber 9 is used for transmitting the signal, the loss of the signal of the extension unit 7a is smaller than that in the case where a coaxial cable is used between the radio unit and the extension unit.

### Modification Example of First Embodiment

In a modification example of the first embodiment, the difference between the first embodiment and the modification example is that an optical signal to which a wavelength division multiplexing (WDM) is applied is transmitted between a radio unit and an extension unit. The modification example of the first embodiment will be described focusing on differences from the first embodiment.

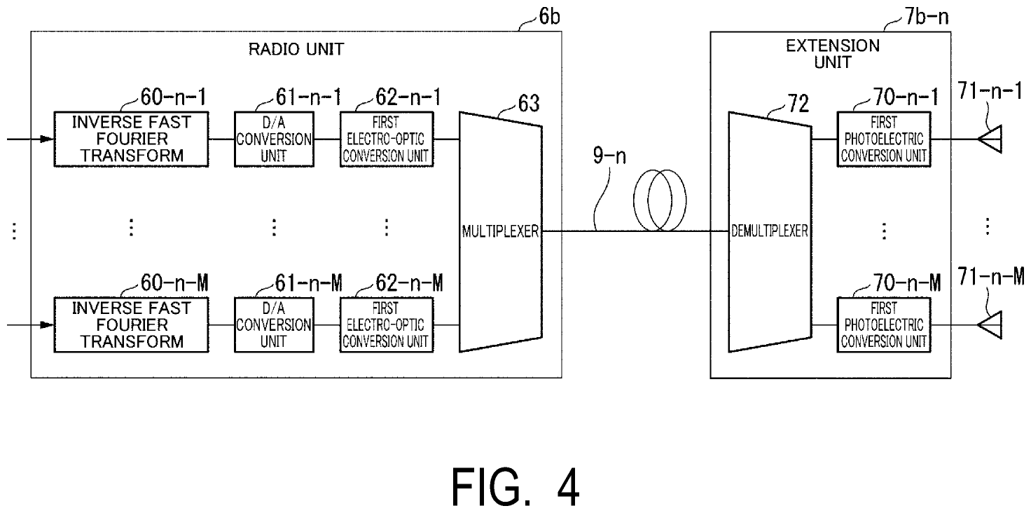

FIG. 4 is a diagram showing a configuration example of the radio unit b and the extension unit 7b according to the modification example of the first embodiment. The radio unit 6b corresponds to the radio unit 6 shown in FIG. 1. The extension unit 7b-n corresponds to the extension unit 7 shown in FIG. 1. The radio unit 6b and the extension unit 7b-n are connected to each other by using the optical fiber 9. The number of the optical fibers 9-n may be smaller than the number of streams (the digital electric signals corresponding to the radio signals) (M). The optical fiber 9-n may not be the multi-core fiber having cores of the number of streams.

The radio unit 6b includes M combinations (systems) of an inverse fast Fourier transform unit 60-n, a D/A conversion unit 61-n, and a first electro-optic conversion unit 62-n. The radio unit 6b further includes a multiplexer 63. The extension unit 7b-n includes M combinations (systems) of a first photoelectric conversion unit 70-n and an antenna element 71-n. The extension unit 7b-n further includes a demultiplexer 72. Note that the extension unit 7b-n may include M amplifiers for amplifying the intensity of the analogue electric signal or the optical signal.

A plurality of first electro-optic conversion units 62-n convert each first analogue electric signal into optical signals having mutually different wavelengths. The multiplexer 63 generates a wavelength division multiplexed optical signal by multiplexing a plurality of optical signals having mutually different wavelengths. The optical fiber 9 outputs the wavelength division multiplexed optical signal to the demultiplexer 72.

The demultiplexer 72 demultiplexes the wavelength division multiplexed optical signal into a plurality of optical signals having mutually different wavelengths. The demultiplexer 72 outputs M optical signals having mutually different wavelengths to M first photoelectric conversion units 70-n. M first photoelectric conversion units 70-n convert the transmitted optical signal into the second analogue electric signal of a predetermined wavelength. The antenna element 71-n-m transmits the downlink radio signal in accordance with the second analogue electric signal.

As described above, the multiplexer 63 multiplexes a plurality of optical signals having mutually different wavelengths to generate the wavelength division multiplexed optical signal. The optical fiber 9 outputs the wavelength division multiplexed optical signal to the demultiplexer 72. The demultiplexer 72 demultiplexes the wavelength division multiplexed optical signal into a plurality of optical signals having mutually different wavelengths. Accordingly, it is possible to reduce the number of optical fibers 9-n.

### Second Embodiment

In a second embodiment, the difference from the first embodiment is that the radio unit executes control of digital beam forming. The second embodiment will be described focusing on differences from the first embodiment.

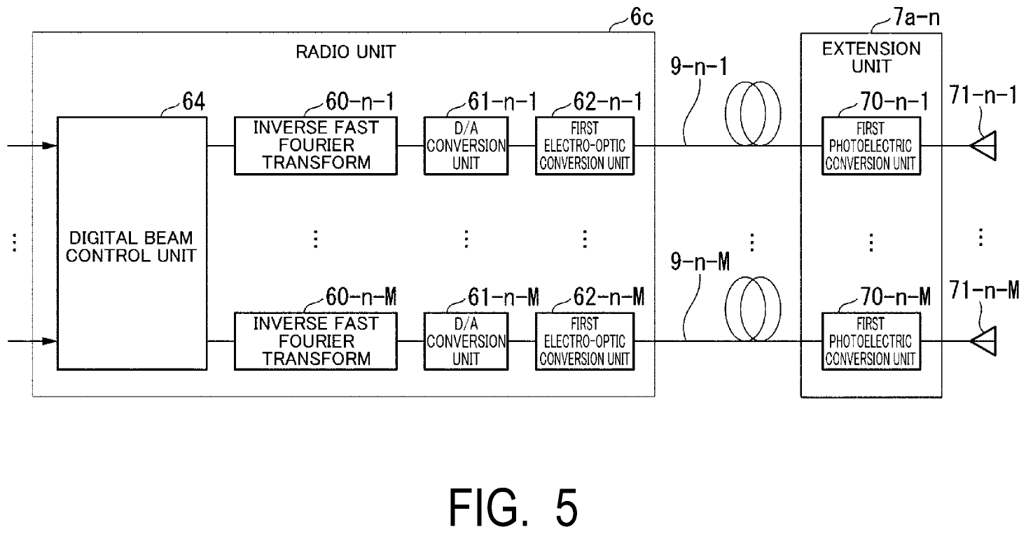

FIG. 5 is a diagram showing a configuration example of a radio unit 6c and an extension unit 7a-n according to a second embodiment. The radio unit 6c corresponds to the radio unit 6 shown in FIG. 1. The extension unit 7a-n corresponds to the extension unit 7-n shown in FIG. 1. In the second embodiment, the radio unit 6c performs the digital beam forming of the downlink radio signal.

The radio unit 6c includes M combinations (systems) of an inverse fast Fourier transform unit 60-n, a D/A conversion unit 61-n, and a first electro-optic conversion unit 62-n. The radio unit 6c further includes a digital beam control unit 64 on the uplink direction (the distributed unit side) with respect to the inverse fast Fourier transform unit 60-n. The extension unit 7a-n includes M combinations (systems) of the first photoelectric conversion unit 70-n and the antenna element 71-n. Note that the extension unit 7a-n may include M amplifiers for amplifying the intensity of the analogue electric signal or the optical signal.

The first electro-optic conversion unit 62-n and the first photoelectric conversion unit 70-n are connected to each other by using the optical fiber 9-n. The optical fiber 9-n may be M single core fibers or a multi-core fiber having M cores.

The radio unit 6c may further include a multiplexer 63. The extension unit 7a-n may further include a demultiplexer 72. In these cases, the number of optical fibers 9-n may be smaller than the number of streams. The optical fiber 9 may not be the multi-core fiber having cores of the number of streams.

The digital beam control unit 64 acquires a predetermined number of downlink streams from the distributed unit 5. The predetermined number of downlink streams are digital electric signals associated with M radio signals. The digital beam control unit 64 executes control of digital beam forming on a digital electric signal associated with the M radio signals. For example, the digital beam control unit 64 adjusts a phase of the digital electric signal associated with the radio signal. The stream “#m” in which the control of the digital beam forming is executed is inputted to the inverse fast Fourier transform unit 60-n-m.

As described above, the digital beam control unit 64 adjusts the phases of the one or more downlink streams (the digital electric signals associated with the radio signals). Thus, digital beam forming can be performed.

### Third Embodiment

In a third embodiment, the difference from the first embodiment is that the analogue beam forming control is executed. More specifically, the difference from the first embodiment is that analogue beam forming control is executed between the D/A conversion unit of the radio unit and the first electro-optical conversion unit of the radio unit. The third embodiment will be described focusing on differences from the first embodiment.

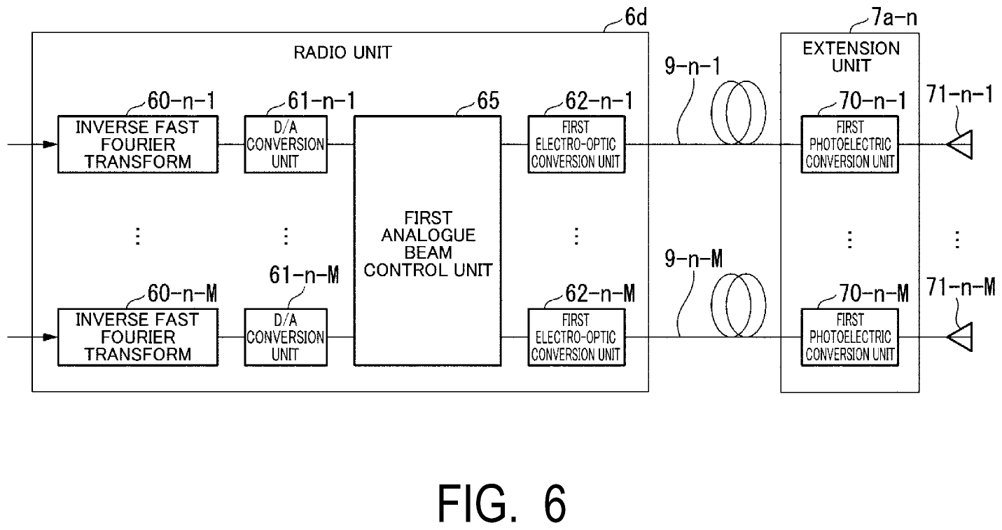

FIG. 6 is a diagram showing a configuration example of a radio unit 6d and an extension unit 7a-n according to the third embodiment. The radio unit 6d corresponds to the radio unit 6 shown in FIG. 1. The extension unit 7a-n corresponds to the extension unit 7-n shown in FIG. 1. In the third embodiment, the radio unit 6d executes analogue beam forming of the downlink radio signal.

The radio unit 6d includes M combinations (systems) of an inverse fast Fourier transform unit 60-n, a D/A conversion unit 61-n, and a first electro-optic conversion unit 62-n. The radio unit 6d further includes a first analogue beam control unit 65 between the D/A conversion unit 61-n and the first electro-optic conversion unit 62-n.

The radio unit 6d may further include a multiplexer 63. The extension unit 7a-n may further include a demultiplexer 72. In these cases, the number of optical fibers 9-n may be smaller than the number of streams (M). The optical fiber 9-n may not be the multi-core fiber having cores of the number of streams.

The first analogue beam control unit 65 executes analogue beam forming in a region (a RF (Radio Frequency) region) of the electric signal of high frequency. That is, the first analogue beam control unit 65 adjusts the phase of each first analogue electric signal outputted from the plurality of D/A conversion units 61-n. The first analogue beam control unit 65 outputs each first analogue electric signal whose phase is adjusted to a plurality of first electro-optic conversion units 62-n.

As described above, the first analogue beam control unit 65 adjusts the phase of each first analogue electric signal outputted from the plurality of D/A conversion units 61. Thus, the analogue beam forming can be performed.

### Fourth Embodiment

In a fourth embodiment, the difference from the third embodiment is that the analogue beam forming control is executed between the first electro-optical conversion unit of the radio unit and the first photoelectric conversion unit of the extension unit. The fourth embodiment will be described focusing on differences from the third embodiment.

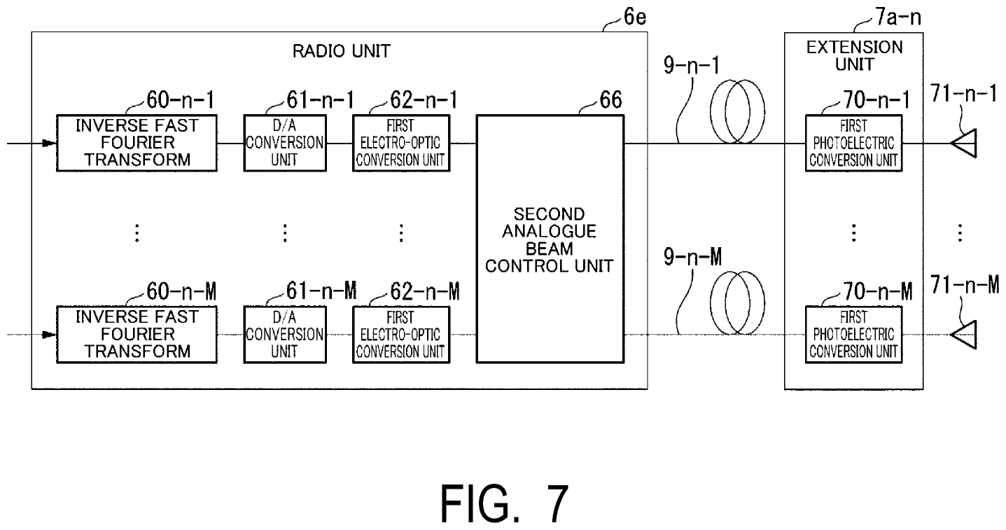

FIG. 7 is a diagram showing a configuration example of a radio unit 6e and an extension unit 7a-n according to the fourth embodiment. The radio unit 6e corresponds to the radio unit 6 shown in FIG. 1. The extension unit 7a-n corresponds to the extension unit 7-n shown in FIG. 1. In the fourth embodiment, the radio unit 6e performs analogue beam forming of the downlink radio signal.

The radio unit 6e includes M combinations (systems) of an inverse fast Fourier transform unit 60-n, a D/A conversion unit 61-n, and a first electro-optic conversion unit 62-n. The radio unit 6e further includes a second analogue beam control unit 66 on the downlink direction (the extension unit side) with respect to the first electro-optic conversion unit 62-n.

The radio unit 6e may further include a multiplexer 63. The extension unit 7a-n may further include a demultiplexer 72. In these cases, the number of optical fibers 9-n may be smaller than the number of streams (M). The optical fiber 9-n may not be the multi-core fiber having cores of the number of streams.

The second analogue beam control unit 66 executes analogue beam forming in a region of the high-frequency optical signal (an RF region). That is, the second analogue beam control unit 66 adjusts the phase of each optical signal outputted from the plurality of first electro-optic conversion units 62-n. The second analogue beam control unit 66 outputs each optical signal whose phase is adjusted to a plurality of first photoelectric conversion units 70-n through the optical fiber 9-n.

As described above, the second analogue beam control unit 66 adjusts the phase of each optical signal outputted from the plurality of first electro-optic conversion units 62. Thus, the analogue beam forming can be performed.

### Fifth Embodiment

In a fifth embodiment, the difference from the first embodiment is that the extension unit executes the control of analogue beam forming. More specifically, the difference from the first embodiment is that the analogue beam forming control is executed between the first photoelectric conversion unit and the antenna element. The fifth embodiment will be described focusing on differences from the first embodiment.

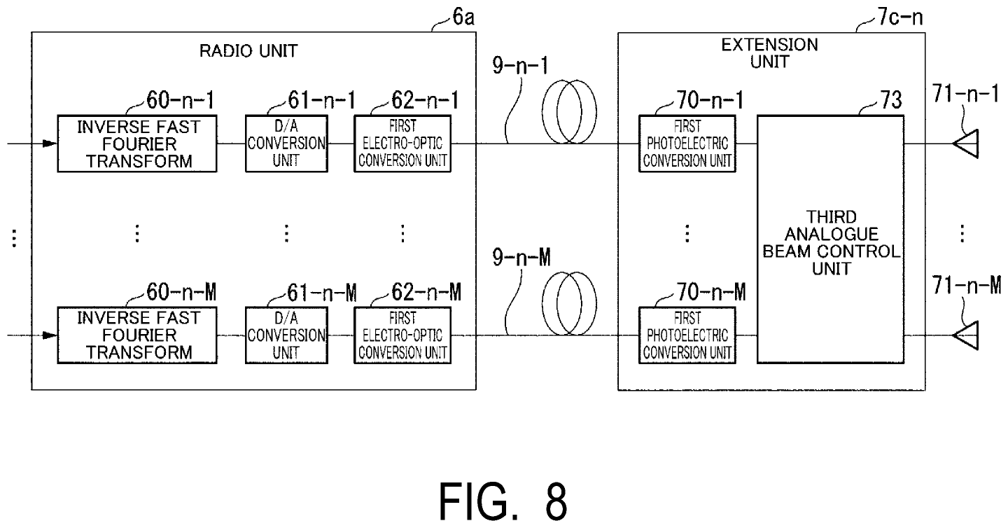

FIG. 8 is a diagram showing a configuration example of a radio unit 6a and an extension unit 7c-n according to the fifth embodiment. The radio unit 6a corresponds to the radio unit 6 shown in FIG. 1. The extension unit 7c-n corresponds to the extension unit 7-n shown in FIG. 1. In the fifth embodiment, the extension unit 7c-n executes the analogue beam forming of the downlink radio signal.

The extension unit 7c-n includes M combinations (systems) of the first photoelectric conversion unit 70-n and the antenna element 71-n. The extension unit 7c-n further includes a third analogue beam control unit 73 between the first photoelectric conversion unit 70-n and the antenna element 71-n. Note that the extension unit 7c-n may include M amplifiers for amplifying the intensity of the analogue electric signal or the optical signal.

The radio unit 6a includes M combinations (systems) of an inverse fast Fourier transform unit 60-n, a D/A conversion unit 61-n, and a first electro-optic conversion unit 62-n. The radio unit 6a may further include a multiplexer 63. The extension unit 7c-n may further include a demultiplexer 72. In these cases, the number of optical fibers 9-n may be smaller than the number of streams. The optical fiber 9 may not be the multi-core fiber having cores of the number of streams.

The third analogue beam control unit 73 executes the analogue beam forming in a region of the high-frequency electric signal (an RF region). That is, the third analogue beam control unit 73 adjusts the phase of each second analogue electric signal outputted from the plurality of first photoelectric conversion units 70-n. The third analogue beam control unit 73 may periodically change the phase adjustment amount. Thus, the third analogue beam control unit 73 periodically changes the transmission direction of the downlink radio signal (beam).

The radio unit 6a may include a control unit for generating control information. The third analogue beam control unit 73 may execute the analogue beam forming on the basis of the control information transmitted from the radio unit 6a. The optical fiber 9 may transmit the control information superimposed on the main signal and the main signal. The control information may be transmitted from the radio unit 6a by using a different path (a communication line for control) from a path of the optical fiber 9 (a path of the main signal). The third analogue beam control unit 73 outputs each of the second analogue electric signals whose phases are adjusted to the plurality of antenna elements 71-n.

As described above, the third analogue beam control unit 73 adjusts the phase of each second analogue electric signal outputted from the plurality of first photoelectric conversion units 70. Thus, the analogue beam forming can be performed.

### Sixth Embodiment

In a sixth embodiment, the difference from the fifth embodiment is that the analogue beam forming control is executed between the first photoelectric conversion unit of the extension unit and the first electro-optical conversion unit of the radio unit. The sixth embodiment will be described focusing on differences from the fifth embodiment.

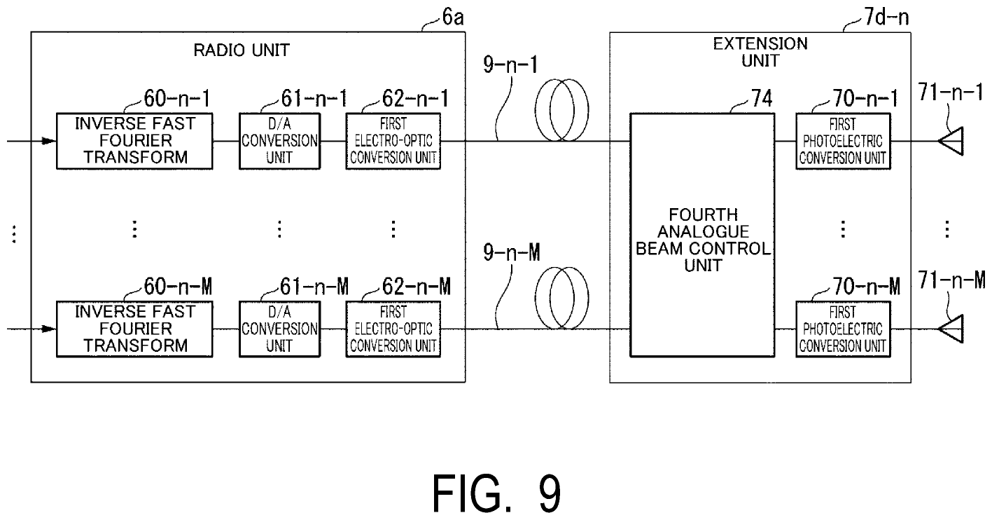

FIG. 9 is a diagram showing a configuration example of a radio unit 6a and an extension unit 7d-n according to the sixth embodiment. The radio unit 6a corresponds to the radio unit 6 shown in FIG. 1. The extension unit 7d-n corresponds to the extension unit 7-n shown in FIG. 1. In the sixth embodiment, the extension unit 7d-n executes the analogue beam forming of the downlink radio signal.

The extension unit 7d-n includes M combinations (systems) of a first photoelectric conversion unit 70-n and an antenna element 71-n. The extension unit 7d-n further includes a fourth analogue beam control unit 74 on the uplink direction (the radio unit side) with respect to the first photoelectric conversion unit 70-n. Note that the extension unit 7d-n may include M amplifiers for amplifying the intensity of the analogue electric signal or the optical signal.

The radio unit 6a may further include a multiplexer 63. The extension unit 7d-n may further include a demultiplexer 72. In these cases, the number of optical fibers 9-n may be smaller than the number of streams. The optical fiber 9 may not be the multi-core fiber having cores of the number of streams.

The fourth analogue beam control unit 74 executes the analogue beam forming in a region of the high-frequency optical signal (an RF region). That is, the fourth analogue beam control unit 74 adjusts the phase of each optical signal outputted from the plurality of first electro-optic conversion units 62-n. The fourth analogue beam control unit 74 outputs each optical signal whose phase is adjusted to a plurality of first photoelectric conversion units 70-n.

As described above, the fourth analogue beam control unit 74 adjusts the phase of each optical signal outputted from the optical fiber 9-n which is M single core fibers. The fourth analogue beam control unit 74 may adjust the phase of each optical signal outputted from the optical fiber 9-n which is a multi-core fiber having M cores. Thus, the analogue beam forming can be performed.

### Seventh Embodiment

A seventh embodiment is a combination of the second embodiment and the third embodiment. In the seventh embodiment, the differences from the second embodiment and the third embodiment will be mainly described.

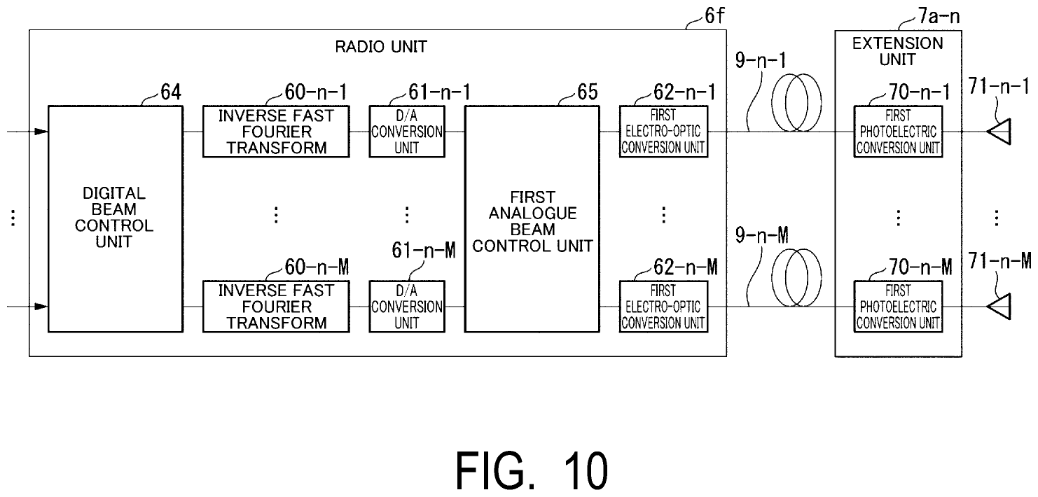

FIG. 10 is a diagram showing a configuration example of a radio unit 6f and an extension unit 7a-n according to the seventh embodiment. The radio unit 6f corresponds to the radio unit 6 shown in FIG. 1. The extension unit 7a-n corresponds to the extension unit 7-n shown in FIG. 1. In the seventh embodiment, the radio unit 6f executes digital beam forming and analogue beam forming for the downlink radio signal. That is, the radio unit 6f executes hybrid beam forming for the downlink radio signal.

Note that, as a comparison, an example of conventional hybrid beam forming is disclosed in reference document 1 (Suyama and 3 others, “5G multi-antenna technique”, NTT DOCOMO technical journal Vol. 23 No. 4 (2016).

The radio unit 6f includes M combinations (systems) of an inverse fast Fourier transform unit 60-n, a D/A conversion unit 61-n, and a first electro-optic conversion unit 62-n. The radio unit 6f further includes a digital beam control unit 64 on the uplink direction (the distributed unit side) with respect to the inverse fast Fourier transform unit 60-n. The radio unit 6f further includes a first analogue beam control unit 65 between the D/A conversion unit 61-n and the first electro-optic conversion unit 62-n.

As described above, the digital beam control unit 64 adjusts the phase of one or more downlink streams (the digital electric signals associated with the radio signals). The first analogue beam control unit 65 adjusts the phase of each first analogue electric signal outputted from the plurality of D/A conversion units 61. Thus, the hybrid beam forming can be performed.

### Eighth Embodiment

An eighth embodiment is a combination of the second embodiment and the fourth embodiment. In the eighth embodiment, the differences from the second embodiment and the fourth embodiment will be mainly described.

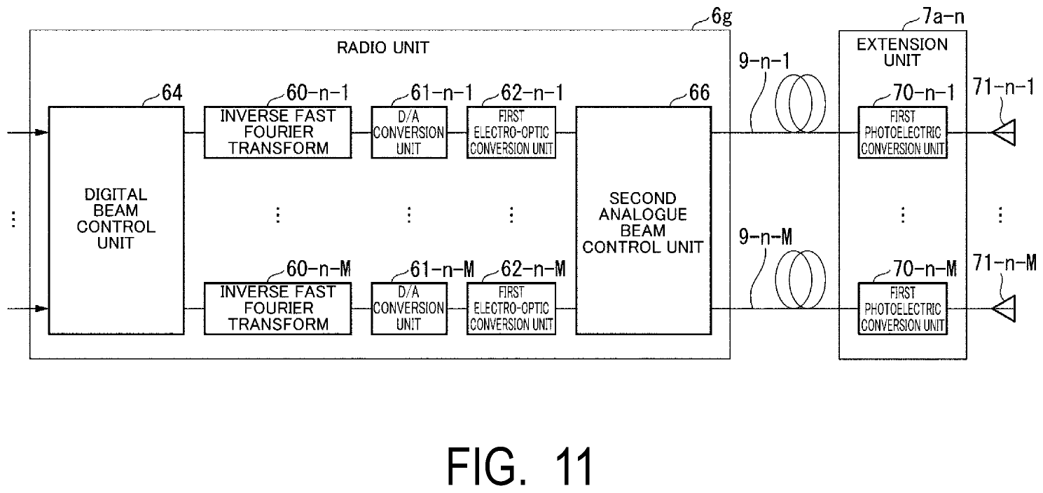

FIG. 11 is a diagram showing a configuration example of a radio unit 6g and an extension unit 7a-n according to the eighth embodiment. The radio unit 6g corresponds to the radio unit 6 shown in FIG. 1. The extension unit 7a-n corresponds to the extension unit 7-n shown in FIG. 1. In the eighth embodiment, the radio unit 6g performs digital beam forming and analogue beam forming for the downlink radio signal. That is, the radio unit 6g executes hybrid beam forming for the downlink radio signal.

The radio unit 6g includes M combinations (systems) of an inverse fast Fourier transform unit 60-n, a D/A conversion unit 61-n, and a first electro-optic conversion unit 62-n. The radio unit 6g further includes a digital beam control unit 64 on the uplink direction (the distributed unit side) with respect to the inverse fast Fourier transform unit 60-n. The radio unit 6g further includes a second analogue beam control unit 66 on the downlink direction (the extension unit side) with respect to the first electro-optic conversion unit 62-n.

As described above, the digital beam control unit 64 adjusts the phases of one or more downlink streams (the digital electric signals associated with the radio signals). The second analogue beam control unit 66 adjusts the phase of each optical signal outputted from the plurality of first electro-optic conversion units 62-n. Thus, the hybrid beam forming can be performed.

### Ninth Embodiment

A ninth embodiment is a combination of the second embodiment and the fifth embodiment. In the ninth embodiment, the differences from the second embodiment and the fifth embodiment will be mainly described.

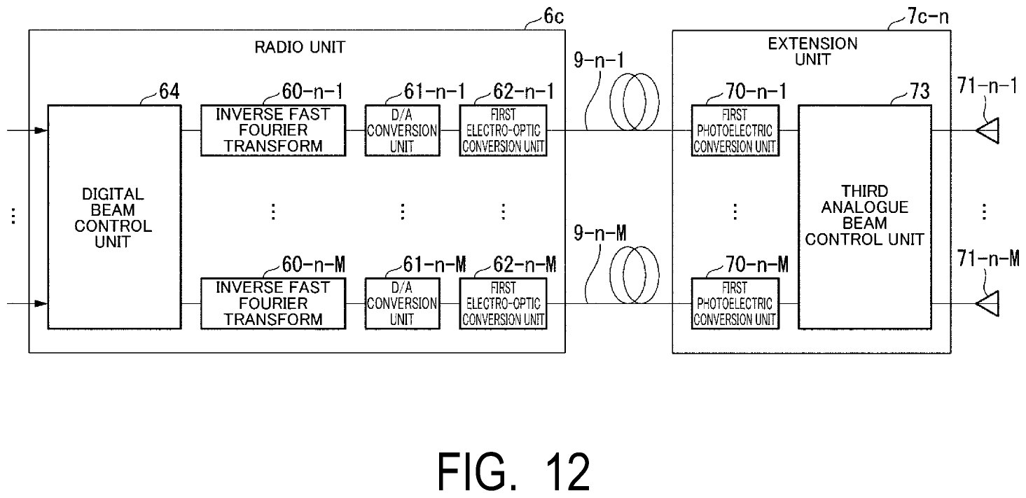

FIG. 12 is a diagram showing a configuration example of a radio unit 6c and an extension unit 7c-n according to the ninth embodiment. The radio unit 6c corresponds to the radio unit 6 shown in FIG. 1. The extension unit 7c-n corresponds to the extension unit 7-n shown in FIG. 1. In the ninth embodiment, the radio unit 6c performs the digital beam forming for the downlink radio signal. The extension unit 7c-n performs the analogue beam forming for the downlink radio signal. That is, the radio unit 6c and the extension unit 7c-n execute the hybrid beam forming for the downlink radio signal.

As described above, the digital beam control unit 64 adjusts the phases of one or more downlink streams (the digital electric signals associated with the radio signals). The third analogue beam control unit 73 adjusts the phase of each second analogue electric signal outputted from the plurality of first photoelectric conversion units 70-n. The third analogue beam control unit 73 may execute the analogue beam forming based on the control information transmitted from the digital beam control unit 64. Thus, the hybrid beam forming can be performed.

### Tenth Embodiment

A tenth embodiment is a combination of the second embodiment and the sixth embodiment. In the tenth embodiment, the differences from the second embodiment and the sixth embodiment will be mainly described.

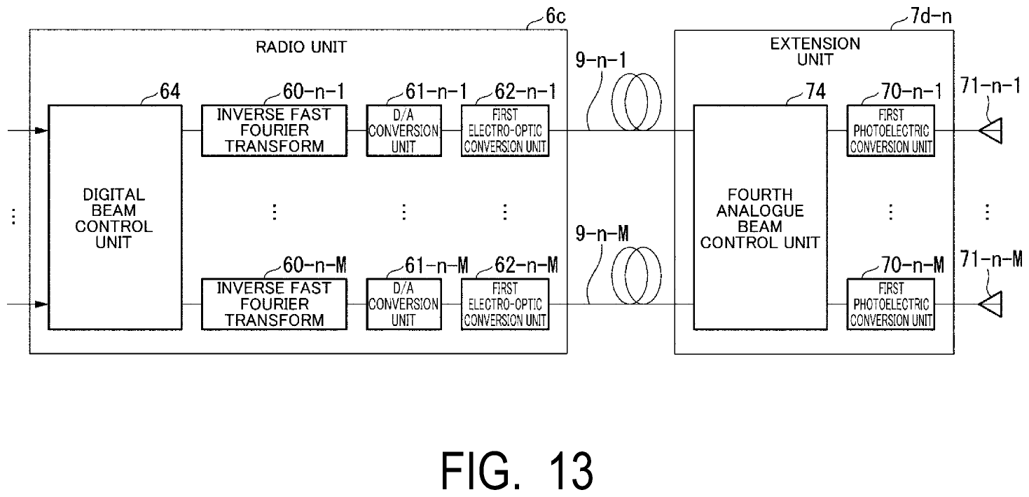

FIG. 13 is a diagram showing a configuration example of a radio unit 6c and an extension unit 7d-n according to the tenth embodiment. The radio unit 6c corresponds to the radio unit 6 shown in FIG. 1. The extension unit 7d-n corresponds to the extension unit 7-n shown in FIG. 1. In the tenth embodiment, the radio unit 6c performs the digital beam forming for the downlink radio signal. The extension unit 7d-n executes the analogue beam forming for the downlink radio signal. That is, the radio unit 6c and the extension unit 7d-n execute the hybrid beam forming for the downlink radio signal.

As described above, the digital beam control unit 64 adjusts the phases of one or more streams (the digital electric signals associated with the stream radio signals). The fourth analogue beam control unit 74 adjusts the phase of each optical signal outputted from the plurality of first electro-optic conversion units 62-n. The fourth analogue beam control unit 74 may execute the analogue beam forming based on the control information transmitted from the digital beam control unit 64. Thus, the hybrid beam forming can be performed.

### Eleventh Embodiment

In the eleventh embodiment, the difference from the first embodiment is that the extension unit transmits the uplink optical signal to the radio unit. The eleventh embodiment will be described focusing on differences from the first embodiment.

In the eleventh embodiment, the extension unit 7 shown in FIG. 1 transmits an optical signal corresponding to an uplink radio signal to the radio unit 6 by using an analogue RoF. The radio unit 6 outputs M uplink streams corresponding to the optical signal to the distributed unit 5. The distributed unit 5 generates the uplink streams by executing predetermined signal processing (for example, decoding) on M uplink streams (the digital electric signals associated with the radio signals). The centralized unit 4 acquires the uplink streams from the distributed unit 5 (DU). The centralized unit 4 generates uplink data by executing predetermined signal processing to the uplink streams (the digital electric signals). The host device 2 acquires the uplink data from the centralized unit 4 (CU).

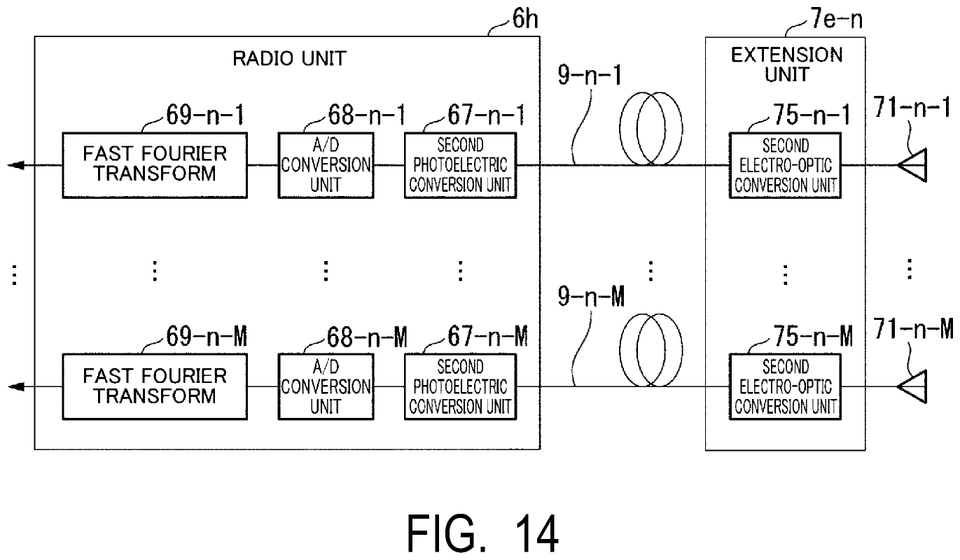

FIG. 14 is a diagram showing a configuration example of a radio unit 6h and an extension unit 7e-n according to the eleventh embodiment. The radio unit 6h corresponds to the radio unit 6 shown in FIG. 1. The extension unit 7e-n corresponds to the extension unit 7-n shown in FIG. 1. In the eleventh embodiment, the radio unit 6h and the extension unit 7e-n do not need to perform the beam forming of the uplink radio signal. The extension unit 7e-n transmits the uplink optical signal to the radio unit 6h by using the analogue RoF.

The radio unit 6h includes M combinations (systems) of a second photoelectric conversion unit 67-n, an A/D conversion unit 68-n (an analogue-to-digital conversion unit), and a fast Fourier transform unit 69-n. The extension unit 7e-n includes M combinations (systems) of an antenna element 71-n and a second electro-optic conversion unit 75-n. Note that the extension unit 7e-n may include M amplifiers for amplifying the intensity of the analogue electric signal or the optical signal.

The second electro-optic conversion unit 75-n and the second photoelectric conversion unit 67-n are connected to each other by using the optical fiber 9-n. The optical fiber 9-n may be M single core fibers or a multi-core fiber having M cores.

Next, operation example of the radio unit 6h and the extension unit 7e-n will be described.

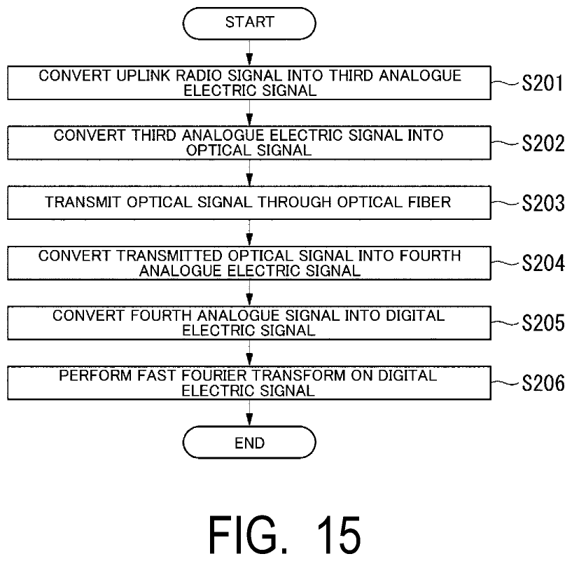

FIG. 15 is a diagram showing an operation example of the radio unit 6h and the extension unit 7e-n in the eleventh embodiment. The extension unit 7e-n acquires the uplink radio signals from the radio terminal (not shown) by using M antenna elements 71.

The antenna element 71-n-m converts the uplink signal into a third analogue electric signal. The antenna element 71-n-m outputs the third analogue electric signal corresponding to the uplink radio signal to the second electro-optic conversion unit 75-n-m (step S201). The second electro-optic conversion unit 75-n-m converts the third analogue electric signal into the optical signal (step S202).

The optical fiber 9-n-m optically transmits the signal converted by the second electro-optic conversion unit 75-n-m to the second photoelectric conversion unit 67-n-m (step S203). The second photoelectric conversion unit 67-n-m converts the transmitted optical signal into a fourth analogue electric signal. The second photoelectric conversion unit 67-n-m transmits the fourth analogue electric signal to the A/D conversion unit 68-n-m (step S204).

The A/D conversion unit 68-n-m converts the fourth analogue electric signal into the digital electric signal. In this way, the extension unit 7e-n transmits the uplink optical signal to the radio unit 6h by using the analogue RoF. The A/D conversion unit 68-n-m outputs the digital electric signal corresponding to the fourth analogue electric signal to the fast Fourier transform unit 69-n-m (step S205). The fast Fourier transform unit 69-n-m executes the fast Fourier transform (FFT) for the digital electric signal corresponding to the fourth analogue electric signal. The fast Fourier transform unit 69-n-m outputs the digital electric signal subjected fast Fourier transform to the distributed unit 5 (step S206).

As described above, the antenna element 71-n-m converts the uplink radio signal into the third analogue electric signal. The second electro-optic unit 75-n-m converts the third analog electric signal into the optical signal. The optical fiber 9-n-m optically transmits the signal converted by the second electro-optic conversion unit 75-n-m to the second photoelectric conversion unit 67-n-m. The second photoelectric conversion unit 67-n-m converts the transmitted optical signal into the fourth analogue electric signal. The A/D conversion unit 68-n-m converts the fourth analog electric signal into the digital signal. The fast Fourier transform unit 69-n-m performs the fast Fourier transform on the digital electric signal corresponding to the fourth analogue electric signal.

Thus, it is possible to suppress the increase in facility cost for expanding the radio communication service providing area.

### Modification Example of Eleventh Embodiment

In a modification example of the eleventh embodiment, the difference from the eleventh embodiment is that the wavelength division multiplexed optical signal is transmitted between the radio unit and the extension unit. The modification example of the eleventh embodiment will be described focusing on differences from the eleventh embodiment.

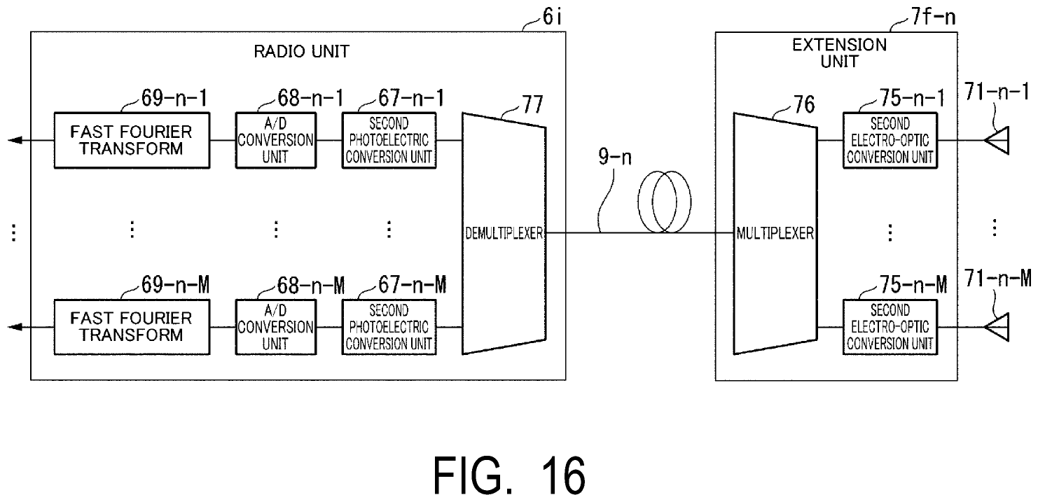

FIG. 16 is a diagram showing a configuration example of a radio unit 6i and an extension unit 7f in the modification example of the eleventh embodiment. The radio unit 6i corresponds to the radio unit 6 shown in FIG. 1. The extension unit 7f-n corresponds to the extension unit 7 shown in FIG. 1. The radio unit 6i and the extension unit 7f-n are connected to each other by using the optical fiber 9. The number of the optical fibers 9-n may be smaller than the number of the streams (the digital electric signals corresponding to the radio signals) (M). The optical fiber 9-n may not be the multi-core fiber having cores of the number of streams.

The radio unit 6i includes M combinations (systems) of a second photoelectric conversion unit 67-n, an A/D conversion unit 68-n (an analogue-to-digital conversion unit), and a fast Fourier transform unit 69-n. The radio unit 6i further includes a demultiplexer 77.

The extension unit 7e-n includes M combinations (systems) of an antenna element 71-n and a second electro-optic conversion unit 75-n. The extension unit 7f-n further includes a multiplexer 76. Note that the extension unit 7e-n may include M amplifiers for amplifying the intensity of the analogue electric signal or the optical signal.

A plurality of second electro-optic conversion units 75-n converts the third analogue electric signal into optical signals having different wavelengths from each other. The multiplexer 76 generates a wavelength division multiplexed optical signal by multiplexing a plurality of optical signals having different wavelengths from each other. The optical fiber 9 outputs the wavelength division multiplexed optical signal to the demultiplexer 77.

The demultiplexer 77 demultiplexes the wavelength division multiplexed optical signal into a plurality of optical signals having different wavelengths from each other. The demultiplexer 77 outputs M optical signals having different wavelengths from each other to M second photoelectric conversion units 67-n. M second photoelectric conversion units 67-n convert the transmitted optical signal into a fourth analogue electric signal having a predetermined wavelength. The A/D conversion unit 68-n-m converts the fourth analog electric signal into the digital signal. The fast Fourier transform unit 69-n-m performs the fast Fourier transform on the digital electric signal corresponding to the fourth analogue electric signal.

As described above, the multiplexer 76 multiplexes the plurality of optical signals having different wavelengths from each other to generate the wavelength division multiplexed optical signal. The optical fiber 9 outputs the wavelength division multiplexed optical signal to the demultiplexer 77. The demultiplexer 77 demultiplexes the wavelength division multiplexed optical signal into the plurality of optical signals having different wavelengths from each other. Accordingly, it is possible to reduce the number of optical fibers 9-n.

In the second to tenth embodiments, the optical fiber 9 may transmit the uplink optical signal as in the eleventh embodiment.

When the optical fiber 9 transmits the uplink optical signal, each of the radio units shown in the second to tenth embodiments includes the above-mentioned fast Fourier transform unit in place of the above-mentioned inverse fast Fourier transform unit. The radio unit includes the A/D conversion unit instead of the D/A conversion unit. The radio unit includes the second photoelectric conversion unit instead of the first electro-optic conversion unit.

When the optical fiber 9 transmits the uplink optical signal, each of the extension units shown in the second to tenth embodiments includes the second electro-optic conversion unit in place of the first photoelectric conversion unit.

### Hardware Configuration Example

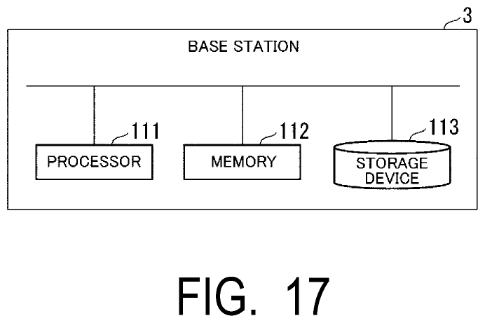

FIG. 17 is a diagram showing a hardware configuration example of the base station 3 (the radio communication device (wireless communication apparatus)) in each embodiment. A part or all of each functional unit of the base station 3 is realized as software by a processor 111 such as a central processing unit (CPU) executing a program stored in a storage device 113 having a non-volatile recording medium (non-temporary recording medium) and a memory 112. The program may be recorded on a computer-readable recording medium. The computer-readable recording medium is, for example, a flexible disk, a magneto-optical disk, a portable medium such as a read only memory (ROM) or a compact disc read only memory (CD-ROM), or a non-temporary recording medium such as a storage device such as a hard disk built in a computer system. A part or all of the functional units of the base station 3 may be realized using hardware including an electronic circuit or circuitry in which a large scale integrated circuit (LSI), an application specific integrated circuit (ASIC), a programmable logic device (PLD), a field programmable gate array (FPGA), or the like is used.

Although the embodiments of the present invention have been described in detail with reference to the drawings, specific configurations are not limited to these embodiments, and designs and the like within a range that does not deviating from the gist of the present invention are also included.

### INDUSTRIAL APPLICABILITY

The present invention is applicable to a radio communication system.

### REFERENCE SIGNS LIST

1 Radio communication system
2 Host device
3 Base station
4 Centralized unit
5 Distributed unit
6, 6a, 6b, 6c, 6d, 6e, 6f, 6g, 6h, 6i Radio unit
7, 7a, 7b, 7c, 7d, 7e, 7f Extension unit
8 Coaxial cable
9 Optical fiber
10 Optical splitter
11 Cover area
12 Cover area
13 Area
60 Inverse fast Fourier transform unit
61 D/A conversion unit
62 First electro-optic conversion unit
63 Multiplexer
64 Digital beam control unit
65 First analogue beam control unit
66 Second analogue beam control unit
67 Second photoelectric conversion unit
68 A/D conversion unit
69 Fast Fourier transform unit
70 First photoelectric conversion unit
71 Antenna element
72 Demultiplexer
73 Third analogue beam control unit
74 Fourth analogue beam control unit
75 Second electro-optic conversion unit
76 Multiplexer
77 Demultiplexer
100 Shielding object
110 Shielding object
111 Processor
112 Memory
113 Storage device
200 Radio unit
201 Cover area
202 Area

1. A radio communication method performed by a radio communication device, comprising:
an inverse fast Fourier transform step of performing inverse fast Fourier transform on a digital electric signal associated with a downlink radio signal;
a digital-to-analogue conversion step of converting the digital electric signal subjected to the inverse fast Fourier transform into a first analogue electric signal;
an electro-optic conversion step of converting the first analogue electric signal into an optical signal;
a step of transmitting the optical signal;
a photoelectric conversion step of converting the transmitted optical signal into a second analogue electric signal; and
a step of transmitting the downlink radio signal corresponding to the second analogue electric signal.

2. The radio communication method according to claim 1, further comprising:
a multiplex step of multiplexing the plurality of optical signals having different wavelengths from each other to generate a wavelength division multiplexed optical signal; and
a demultiplex step of demultiplexing the wavelength division multiplexed optical signal into the plurality of optical signals having different wavelengths from each other,
wherein
in the step of transmitting the optical signal, an optical fiber transmits the wavelength division multiplexed optical signal.

3. The radio communication method according to claim 1, further comprising:
a digital beam control step of adjusting a phase of the digital electric signal.

4. The radio communication method according to claim 1, further comprising:
an analogue beam control step of adjusting the phase of the optical signal, the first analogue electric signal or the second analogue electric signal.

5. A radio communication device comprising:
an inverse fast Fourier transformer configured to perform inverse fast Fourier transform on a digital electric signal associated with a downlink radio signal;
a digital-to-analogue converter configured to convert the digital electric signal subjected to the inverse fast Fourier transform into a first analogue electric signal;
an electro-optic converter configured to convert the first analogue electric signal into an optical signal;
an optical fiber configured to transmit the optical signal;
a photoelectric converter configured to convert the transmitted optical signal into a second analogue electric signal; and
an antenna element configured to transmit the downlink radio signal corresponding to the second analogue electric signal.

6. The radio communication device according to claim 5, further comprising:
a multiplexer configured to multiplex the plurality of optical signals having different wavelengths from each other to generate a wavelength division multiplexed optical signal; and
a demultiplexer configured to demultiplex the wavelength division multiplexed optical signal into the plurality of optical signals having different wavelengths from each other, wherein
the optical fiber transmits the wavelength division multiplexed optical signal.

7. The radio communication device according to claim 5, further comprising:
a digital beam controller configured to adjust a phase of the digital electric signal.

8. The radio communication device according to claim 5, further comprising:
an analogue beam controller configured to adjust the phase of the optical signal, the first analogue electric signal or the second analogue electric signal.

9. The radio communication device according to claim 6, further comprising:
a digital beam controller configured to adjust a phase of the digital electric signal.

10. The radio communication device according to claim 6, further comprising:
an analogue beam controller configured to adjust the phase of the optical signal, the first analogue electric signal or the second analogue electric signal.

11. The radio communication device according to claim 7, further comprising:
an analogue beam controller configured to adjust the phase of the optical signal, the first analogue electric signal or the second analogue electric signal.
